(19) United States
(12) Patent Application Publication
(10) Pub. No.: US 2020/0299008 A1
(43) Pub. Date: Sep. 24, 2020

(54) FILLING APPARATUS AND FILLING METHOD FOR POWDER PARTICLE MATERIAL

(71) Applicant: SUMITOMO SEIKA CHEMICALS CO., LTD., Kako-gun, Hyogo (JP)

(72) Inventors: Hideki Matsushita, Himeji-shi, Hyogo (JP); Kenji Nakamura, Himeji-shi, Hyogo (JP); Hideo Kazama, Himeji-shi, Hyogo (JP)

(73) Assignee: SUMITOMO SEIKA CHEMICALS CO., LTD., Kako-gun, Hyogo (JP)

(21) Appl. No.: 16/088,756

(22) PCT Filed: Feb. 16, 2017
(86) PCT No.: PCT/JP2017/005663

§ 371 Date: Sep. 26, 2018

(30) Foreign Application Priority Data
Mar. 31, 2016 (JP) 2016-070589

(51) Int. Cl. B65B 1/22; B65B 1/06; B65B 1/34

(52) U.S. Cl. CPC B65B 1/22; B66F 3/247; B65B 1/34; B65B 1/06

(57) ABSTRACT

Filling of a powder particle material is executed for a flexible container bag (hereinafter, referred to as “flex container bag”) by executing a powder particle material filling step of filling the flex container bag with the powder particle material by supplying the powder particle material to the flex container bag, and a tapping step of executing a lifting operation of lifting up the flex container bag filled with the powder particle material to cause the flex container bag to be distant from a floor surface or a base bed thereabove and a dropping operation of dropping the flex container bag by releasing the lifting by the lifting operation to cause the flex container bag to collide with the floor surface or the base bed. The handling property of the flex container bag filled with the powder particle material can further be improved.

### TECHNICAL FIELD

This disclosure relates to an apparatus that fills and a method of filling a flexible container bag (hereinafter, referred to as “flex container bag”) with powder particle material.

### BACKGROUND ART

The flex container bag is widely used as a lightweight and inexpensive container to be filled with powder particle material. It is demanded to the flex container bag to be filled with the powder particle material at a further high filing rate. From this viewpoint, for example, an apparatus described in Patent Document 1 is known as a traditional powder particle material filling apparatus.

The apparatus of Patent Document 1 increases the filing rate of powder by giving impacts to the powder in a flex container bag by repeatedly executing an operation of lifting up a support bed having the flex container bag placed thereon that is filled with the powder and thereafter dropping the support bed.

### PATENT DOCUMENT

Patent Document 1: Japanese Laid-Open Patent Publication No. 9-254902

### SUMMARY OF THE INVENTION

### Problems to be Solved by the Invention

From the viewpoints of storage and transportation of the flex container bag filled with a powder particle material, it has recently been demanded to further improve the handling property in addition to further increasing the filling rate of the powder particle material filling the flex container bag.

An object of this disclosure is to provide a filling apparatus and a filing method for a powder particle material, each capable of further improving the handling property of the flex container bag filled with the powder particle material.

### Means for Solving Problems

In order to achieve the object, the filling apparatus and the filling method for a powder particle material of this disclosure are configured as follows.

According to an aspect of this disclosure, a filling apparatus for a powder particle material is provided, that includes a powder particle material supplying device that supplies the powder particle material to a flex container bag, a lifting device that lifts up the flex container bag arranged on a floor surface or a base bed therefrom, and a control device that is operable to control the lifting device to execute a tapping process that includes a lifting operation of lifting up the flex container bag filled with the powder particle material by the powder particle material supplying device using the lifting device to cause the flex container bag to be distant from the floor surface or the base bed and a dropping operation of dropping the flex container bag by releasing the lifting by the lifting device to cause the flex container bag to collide with the floor surface or the base bed.

According to another aspect of this disclosure, a filling method for a powder particle material is provided that includes a powder particle material filling step of filling the flex container bag with the powder particle material by supplying the powder particle material to the flex container bag, and a tapping step of executing a lifting operation of lifting up the flex container bag filled with the powder particle material to cause the flex container bag to be distant from the floor surface or the base bed thereabove and a dropping operation of dropping the flex container bag by releasing the lifting by the lifting operation to cause the flex container bag to collide with the floor surface or the base bed.

### Effect of the Invention

According to the filling apparatus and the filling method for a powder particle material of this disclosure, the handling property of the flex container bag filled with the powder particle material can further be improved.

### BRIEF DESCRIPTION OF DRAWINGS

FIG. 1 is a diagram of the configuration of a filling apparatus for a powder particle material according to an embodiment of this disclosure.

FIG. 2 is a flowchart of a filling method executed by the filling apparatus of the embodiment.

FIG. 3 is an explanatory diagram of process steps of the filling method of the embodiment.

FIG. 4 are schematic diagrams each of the state where flex container bags each filled with the powder particle material are stacked on each other in two tiers ((A) for Example and (B) for Comparative Example).

### EMBODIMENT(S) FOR CARRYING OUT THE INVENTION

### Aspects of this Disclosure

A filling apparatus for a powder particle material according to a first aspect of this disclosure includes a powder particle material supplying device that supplies the powder particle material to a flex container bag, a lifting device that lifts up the flex container bag arranged on a floor surface or a base bed, and a control device that causes the lifting device to execute a tapping process including a lifting operation of lifting up the flex container bag filled with the powder particle material by the powder particle material supplying device using the lifting device to cause the flex container bag to be distant from the floor surface or the base bed thereabove and a dropping operation of dropping the flex container bag by releasing the lifting by the lifting device to cause the flex container bag to collide with the floor surface or the base bed.

A filling apparatus for a powder particle material according to a second aspect of this disclosure is the filling apparatus of the first aspect, wherein the lifting device includes a lifting member that releasably engages with an upper portion of the flex container bag and an elevating and lowering device that elevates and lowers the lifting member, and wherein the elevating and lowering device has a lifting releasing function of causing the flex container bag lifted through the lifting member to substantially freely fall.

A filling apparatus for a powder particle material according to a third aspect of this disclosure is the filling apparatus of the first or the second aspect, wherein the control device is operable to control the lifting device to execute the tapping process such that the flex container bag is lifted up to a height of at least 80 mm or higher from the floor surface or the base bed by the lifting operation and the dropping operation is thereafter executed.

A filling method for a powder particle material according to a fourth aspect of this disclosure includes a powder particle material filling step of filling the flex container bag with the powder particle material by supplying the powder particle material to the flex container bag, and a tapping step of executing a lifting operation of lifting up the flex container bag filled with the powder particle material to cause the flex container bag to be distant from the floor surface or the base bed thereabove and a dropping operation of dropping the flex container bag by releasing the lifting by the lifting operation to cause the flex container bag to collide with the floor surface or the base bed.

A filling method for a powder particle material according to a fifth aspect of this disclosure is the filling method of the fourth aspect, wherein at the tapping step, the lifting operation is executed by elevating the lifting member that releasably engages with the upper portion of the flex container bag, and wherein the dropping operation is executed by causing the flex container bag to substantially freely fall by releasing the lifting by the lifting member.

A filling method for a powder particle material according to a sixth aspect of this disclosure is the filling method of the fourth or the fifth aspect, wherein, at the tapping step, the flex container bag is lifted up to a height of at least 80 mm or higher from the floor surface or the base bed by the lifting operation and the dropping operation for the flex container bag is thereafter executed.

A storage method for flex container bags according to a seventh aspect of this disclosure includes a step of stacking on the flex container bags each other in a vertical direction in two or more tiers, each of the flex container bags being filled with a powder particle material in a filling amount of 500 kg to 1,500 kg using the filling method for a powder particle material according to any one of the fourth to sixth aspects.

### Embodiment

An embodiment according to this disclosure will be described in detail below with reference to the drawings.

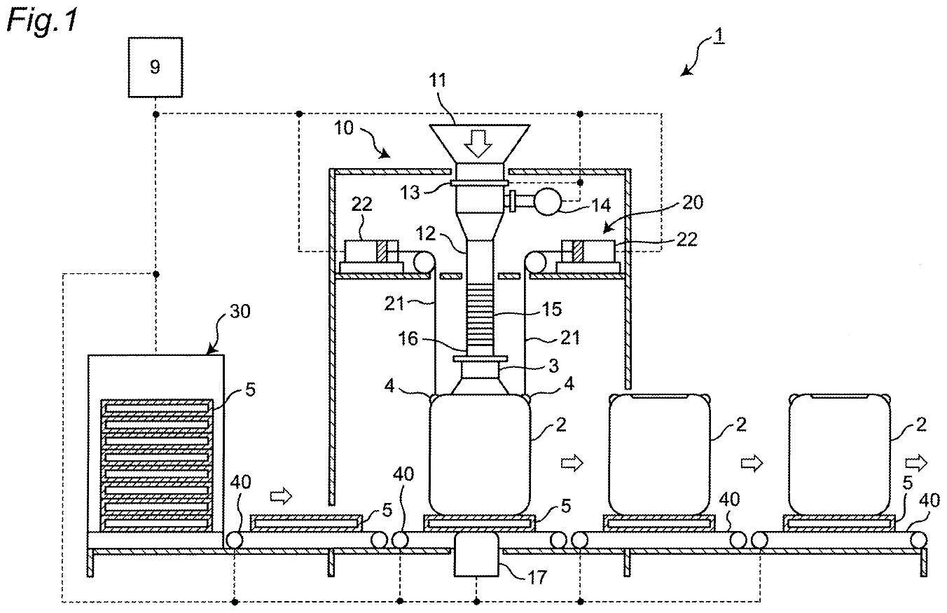

FIG. 1 depicts a schematic configuration of a filling apparatus for a powder particle material according to an embodiment of this disclosure. The filling apparatus of this embodiment is an apparatus that fills a flex container bag with a water-absorbing resin powder particle material as the powder particle material in a predetermined amount.

As depicted in FIG. 1, the filling apparatus 1 includes a powder particle material supplying device 10 that supplies the powder particle material to a flex container bag 2, a lifting device 20 that lifts up the flex container bag 2, and a control device 9. The filling apparatus 1 may include a pallet supplying device 30 and a carrying device 40 for a pallet 5.

The flex container bag 2 is used as a container to be filled with the powder particle material. The flex container bag 2 includes, for example, a foldable and lightweight material, and is also a relatively inexpensive container to be filled. As depicted in FIG. 1, the flex container bag 2 has a bottomed and bag-shaped structure. An opening 3 to fill the flex container bag 2 therethrough with the powder particle material and plural lifting belts (engaging parts) 4 that releasably engage with hooks or the like to lift up the flex container bag 2 as described later are disposed in the upper portion of the flex container bag 2. The lifting belts 4 are disposed at, for example, four points at uniform interval pitches in the upper portion of the flex container bag 2 while various aspects may be employed for the number of the lifting belts 4 to be installed and the intervals for the installation. The flex container bag 2 is carried in the state where the flex container bag 2 is placed on the pallet 5.

The flex container bag 2 is advantageously structured to have plural layers of two or more layers. An advantageous flex container bag 2 includes an inner layer and an outer layer. The material constituting the inner layer advantageously has a material quality capable of preventing any leak of the powder particle material. When the material quality of the inner layer is a material quality that retains the moisture-proof property, this material quality can more advantageously be employed. An example thereof is, for example, polyethylene (PE), polypropylene (PP), polyethylene terephthalate (PET), polyvinyl chloride (PVC), an aluminum laminate material, or an aluminum vapor-deposited material. A woven cloth excellent in the strength, or the like is advantageously used as the material constituting the outer layer. Similar to the material constituting the inner layer, a material having a property capable of preventing any leak of the powder particle material and having the moisture-proof property is used as the material constituting the outer layer and, for example, polyethylene, polypropylene, polyester, and nylon are advantageously used.

The powder particle material to fill the flex container bag 2 has the fluidity substantially at a degree for the powder particle material to be able to flow in a shooter 12 that is a supply pathway and freely fall naturally. Examples of the powder particle material applied to this disclosure include, for example, cereals such as rice, barley and wheat, and foxtail millet, powder chemicals such as sodium sulfate and sodium sulfite, inorganic powders such as zeolite, kaolin, and talc, powder high-molecular-weight compounds such as crushed polyethylene, crushed polypropylene, crushed polyvinyl chloride, and water-absorbing resins, powder gardening materials such as fertilizers and leaf soil, and powder civil engineering materials such as cement, sea sand, and earth and sand. A higher filling rate tends to be acquired in this disclosure when the bulk specific gravity measured in accordance with “JIS-K-6720, Testing Methods for Polyvinyl Chloride Resins, 3.3 Method for Bulk Specific Gravity” as a physical property of the powder particle material is preferably 0.3 to 0.9 mL/g and more preferably 0.5 to 0.8 mL/g. In this embodiment, the description will be made taking an example of the case where a water-absorbing resin powder particle material is used as the powder particle material.

The water-absorbing resin powder particle material to be a preferred example of the powder particle material to fill the flex container bag 2 is the powder particle material used in a wide range of fields such as the use for sanitary materials such as sanitary products and disposable diapers, the use for agriculture and gardening such as water-retaining agents and agricultural ameliorants, or the use for industrial materials such as water-stopping agents and dew-condensation preventing agents. The water-absorbing resin powder particle material used in these various types of use is a properly cross-linked high-molecular-weight compound and, for example, starch-based water-absorbing resins such as a hydrolysate of a starch-acrylonitrile graft copolymer and a neutralized product of a starch-acrylic acid graft copolymer, a saponified product of a vinyl acetate-acrylic acid ester copolymer, and partially neutralized products of polyacrylic acid are known. The water-absorbing resin powder particle material of the embodiment is, for example, a powder particle material whose median particle size is 100 to 600 μm and is, more specifically, 200 to 500 μm. The median particle size is measured in accordance with the method described in, for example, WO 2012-176342. A water-absorbing resin powder particle material having such fine powders blended therein may be used as silica, a titanium oxide, kaolin, talc, bentonite, and zeolite as additives.

The pallet supplying device 30 is arranged on the upstream side of a carrier line of the flex container bag 2 in the filling apparatus 1. The pallet supplying device 30 accommodates the plural pallets 5 that are stacked on each other, and sequentially supplies the accommodated pallets 5 to the carrier line. The pallet 5 has, for example, a substantially quadrangular shape in a planar view, and an opening through which an arm part (a fork part) for receiving the luggage of a forklift can be inserted is disposed on the side face thereof.

The plural carrying devices 40 constitute the carrier line by being installed in a string. The carrying device 40 disposed on the upstream side is connected to the pallet supplying device 30 and carries the pallet 5 itself or the pallet 5 together with the flex container bag 2 placed on the pallet 5 along the carrier line. The carrying device 40 carries the pallet 5 and the flex container bag 2 to position the pallet 5 at the filling position for the powder particle material by the powder particle material supplying device 10 and to carry the flex container bag 2 that is placed on the pallet 5 and that is already filled with the powder particle material from the filling position. Carrying devices having various forms may each be employed as the carrying device 40 and, for example, a chain conveyer-type carrying device may be employed.

The powder particle material supplying device 10 includes a hopper 11 (whose portion in the lower portion thereof only is depicted in FIG. 1) that accumulates the powder particle material to be able to be supplied, and a shooter 12 that is a supply pathway connecting the hopper 11 and the flex container bag 2 to each other (that is the supply pathway causing the hopper 11 and the flex container bag 2 to communicate with each other). The shooter 12 is connected, on its upper end, to the lower portion of the hopper 11 and is connected, at a supply entrance 16 to be its lower end, to the opening 3 of the flex container bag 2 that is positioned at the filling position. On the lower end of the shooter 12, a connection mechanism (such as a clamp) may be disposed to releasably connect the opening 3 of the flex container bag 2 thereto.

In the upper portion of the shooter 12, a cutting gate 13 is disposed that controls the supply amount of the powder particle material to be supplied from the hopper 11 to the flex container bag 2. The cutting gate 13 controls the supply amount of the powder particle material by adjusting the aperture of the bottom portion of the hopper 11.

In the course of the shooter 12, a blower 14 to supply air (atmosphere) is connected thereto. Air can be supplied by the blower 14 to the flex container bag 2 connected to the shooter 12 through the shooter 12. The shooter 12 includes a stretching and shortening part 15 that can be stretched and shortened in the up-and-down direction. As descried later, when the flex container bag 2 connected to the shooter 12 is lifted up, the stretching and shortening part 15 is shortened to thereby avoid any obstacle caused by the stretching and shortening part 15 to the lifting operation for the flex container bag 2. As described later, when the flex container bag 2 connected to the shooter 12 is dropped, the stretching and shortening part 15 is stretched to thereby avoid any obstacle caused by the stretching and shortening part 15 to the dropping operation for the flex container bag 2.

A load cell 17 that measures the weight of the powder particle material filling the flex container bag 2 is disposed at the filling position. The flex container bag 2 is arranged on the load cell 17 through the pallet 5 and the filling amount of the powder particle material in the flex container bag 2 is measured by the load cell 17. The load cell 17 outputs the filling amount of the powder particle material to the control device 9 as load data, and the opening and the closing of the cutting gate 13 (that is, the supply and discontinuation of the supply of the powder particle material) is controlled based on the load data. The configuration that measures the weight of the powder particle material filling the flex container bag 2 using the load cell may employ another form. For example, a form may be employed according to which a frame lifting the flex container bag 2 is disposed, the load cell is installed to measure the weight of the overall frame, and the weight of the powder particle material filling the flex container bag 2 is measured.

The lifting device 20 is a device that executes the lifting operation that causes the flex container bag 2 arranged on the carrying device 40 through the pallet 5 to be distant from the carrying device 40 thereabove at the filling position. The lifting device 20 includes plural lifting chains 21 that engage with the lifting belts 4 disposed in the upper portion of the flex container bag 2, and elevating and lowering devices 22 that each elevate and lower the lifting chain 21. In this embodiment, the case where the carrying device 40 and the pallet arranged on the carrying device 40 are used as a base bed and the flex container bag 2 is lifted up to be distant from the base bed thereabove is taken as the example while the case where the flex container bag 2 is lifted up from the floor surface may be taken.

The lifting chains 21 each have an engaging member such as a hook disposed at its lower end, the hook releasably engages with the lifting belt 4 of the flex container bag 2, and the flex container bag 2 is thereby enabled to be lifted. In this embodiment, the lifting chain 21 is taken as the example of the lifting member while any lifting member may be employed only when this lifting member can lift the flex container bag 2 already filled with the powder particle material, and a belt or a wire may be employed.

The elevating and lowering device 22 is a device that is connected to the upper portions of the lifting chain 21, that elevates and lowers the lifting chain 21, and that holds the lifting chain 21 at a lifting and lowering position. The elevating and lowering devices 22 lift up the flex container bag 2 by elevating the lifting chains 21 and each have a function of releasing the holding of the lifting chain 21 to cause the flex container bag 2 lifted up to a predetermined height position to substantially freely fall (a lifting release function). For example, an air cylinder device may be used as the elevating and lowering device 22 having this function. For example, the lifting chains 21 may be elevated using the force generated by injecting air into the air cylinder and the holding of the lifting chains 21 may be released by rapidly removing the injected air. In addition, a winching mechanism using a clutch such as a one-way clutch may be employed as the elevating and lowering device 22, and a mechanism is advantageous that has low mechanical resistance especially during the dropping.

The control device 9 is a device that executes the control for each of the operations of the constituent devices in the filling apparatus 1 correlating the operations with each other. For example, the supply operation for the pallet 5 by the pallet supplying device 30, the carrying operation for the pallet 5 or the flex container bag 2 by the carrying device 40, and the filling operation for the powder particle material by the powder particle material supplying device 10 are controlled by the control device 9 for each of these operations to be executed. The tapping process for the flex container bag 2 by the lifting device 20 described later is executed by the control device 9.

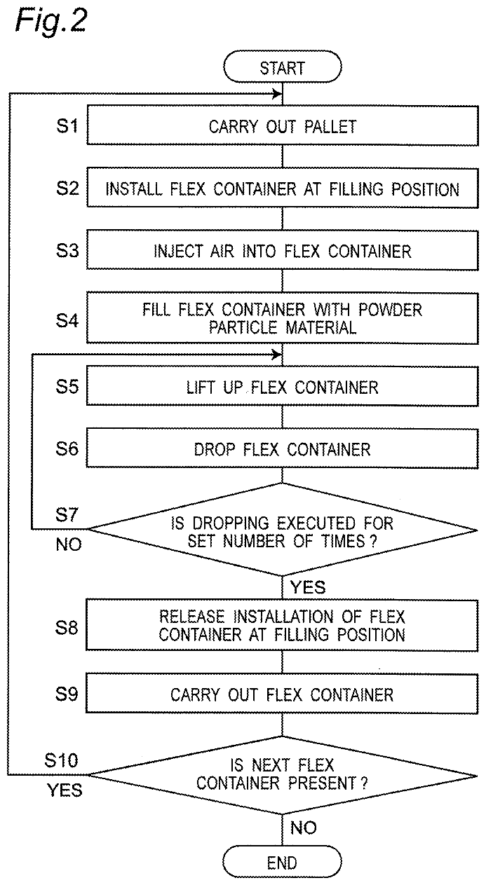

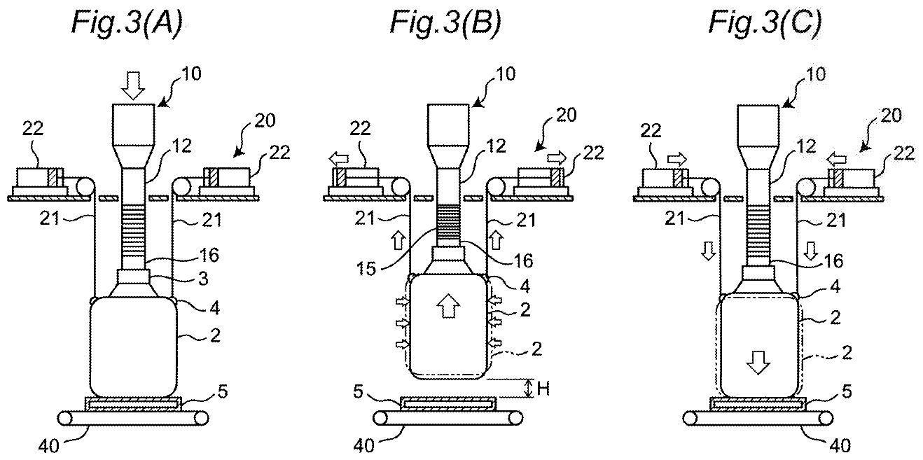

Subsequently, the filling method for the powder particle material to the flex container bag 2 executed by the filling apparatus 1 of this embodiment that has the above configuration. FIG. 2 depicts a flowchart of the filling method executed by the filling apparatus 1, and FIG. 3 depicts an explanatory diagram of the process steps of the filling method. In the flowchart of FIG. 2, the flex container bag 2 is further shortened to be referred to as “flex container”.

At step S1 of the flowchart of FIG. 2, the pallet 5 is carried out from the pallet supplying device 30. By the carrying device 40, the carried out pallet 5 is carried to the filling position that is a position under the powder particle material supplying device 10, to be positioned at the filling position.

Subsequently, the flex container bag 2 that is empty is installed (placed) on the pallet 5 at the filling position (step S2). Specifically, the flex container bag 2 that is folded is arranged on the pallet 5 and the opening 3 of the flex container bag 2 is attached to the supply entrance 16 of the shooter 12 using the connection mechanism such as a clamp. The plural lifting belts 4 of the flex container bag 2 are hooked on the engaging members such as hooks each disposed on the lower end of the lifting chain 21 of the lifting device 20.

Subsequently, air is thereafter injected into the flex container bag 2 through the shooter 12 by the blower 14 (step S3). This injection of air establishes the state where the flex container bag 2 is inflated to be able receive the powder particle material. Before and after the injection of the air into the flex container bag 2, the zero-point of the load cell 17 is adjusted. The adjustment is executed for the load of the powder particle material to become zero in the state where the empty flex container bag 2 and the pallet 5 are placed on the load cell 17.

Subsequently, as depicted in FIG. 3(A), filling of the flex container bag 2 with the powder particle material by the powder particle material supplying device 10 is started (step S4: a powder particle material filling step). Specifically, the cutting gate 13 is opened and the powder particle material accumulated in the hopper 11 is supplied into the flex container bag 2 through the shooter 12. During this, the load measurement is executed by the load cell 17 and, when the load value (that is, the filling amount) set in advance is detected, the cutting gate 13 is closed by the control device 9 and the supply of the powder particle material is discontinued. The supply of the powder particle material may be executed in a stepwise manner. For example, when the filling amount of the powder particle material into the flex container bag 2 is 800 kg, the supply of the powder particle material may be executed with the cutting gate 13 fully opened until a filling amount of 770 kg is detected (a large-scale supply) and, for the remaining 30 kg, the aperture of the cutting gate 13 is reduced and the supply of the powder particle material is slowly executed (a small-scale supply). When the supply in the stepwise manner is executed as above, precise filling can be executed maintaining the high-speed filling to some extent.

When the flex container bag 2 is filled with the powder particle material, the tapping step (a process) of lifting up and dropping the flex container bag 2 is executed (steps S5 to S7).

Air is injected into each of the elevating and lowering devices 22 and the lifting chains 21 are elevated by the elevating and lowering devices 22. The flex container bag 2 filled with the powder particle material is thereby lifted by the lifting chains 21 and the bottom portion of the flex container bag 2 is caused to be distant above the pallet 5 (step S5: the lifting operation). When the flex container bag 2 is lifted up to a height position H set in advance, the elevation of the lifting chains 21 by the elevating and lowering devices 22 is discontinued.

As depicted in FIG. 3(B), a tension is applied to mainly the side face of the flex container bag 2 by the execution of the lifting operation for the flex container bag 2 as above. The flex container bag 2 filled with the powder particle material is thereby shaped to be narrowed in the width direction and to be stretched in the up-and-down direction. The shooter 12 has the stretching and shortening part 15 disposed thereon. The stretching and shortening part 15 is shortened when the lifting operation is executed, and the lifting operation is therefore not obstructed by the shooter 12.

Subsequently, as depicted in FIG. 3(C), the lifting by the lifting operation is released by removing the air injected into the elevating and lowering devices 22 to cause the flex container bag 2 to drop (step S6: the dropping operation). Because this dropping operation is executed by rapidly removing the air injected into the air cylinder, the flex container bag 2 filled with the powder particle material substantially freely falls by its own weight. The dropped flex container bag 2 collides with the pallet 5 on the carrying device 40.

The positional energy corresponding to the height position of the lifting and the self-weight is applied to the powder particle material in the flex container bag 2 as the collisional energy, by the substantial free-fall and the collision of the flex container bag 2. The air (gaps) present among the filling powder particles is thereby removed and the filling rate of the powder particle material in the flex container bag 2 can be increased.

Subsequently, the control device 9 checks whether the tapping process is executed for the dropping session number set in advance (the number of the tapping process sessions) (step S7). When the control device 9 determines that the tapping process is executed for the number of times smaller the set dropping session number, the lifting operation (step S5) and the dropping operation (step S6) are again executed. On the other hand, when the control device 9 determines at step S7 that the tapping process is executed for the set dropping session number of times, the tapping process at steps S5 to S7 is completed.

Subsequently, the installment of the flex container bag 2 at the filling position is thereafter released, that is, the connection thereof to the shooter 12 is released and the hooking of the lifting belts 4 on the lifting chains 21 is detached (step S8). The flex container bag 2 having its installment released is carried out by the carrying device 40 in the state where the flex container bag 2 is placed on the pallet 5, and is sent from the filling position to the downstream side of the carrier line (step S9).

For the flex container bag 2 that is carried out, planarization work for the surface of the powder particle material filling the flex container bag 2 and sealing work for the opening 3 of the flex container bag 2 are executed.

On the other hand, the control device 9 checks whether any flex container bag 2 to be filled next with the powder particle material is present in the filling apparatus 1. When the control device 9 determines that the next flex container bag 2 is present, the processes at steps S1 to S9 are executed for the next flex container bag 2. On the other hand, when the control device 9 determines that no next flex container bag 2 is present, the control device 9 causes the filling of the powder particle material to come to an end.

For example, the tapping operation of lifting up the flex container bag 2 whose filling amount of the powder particle material is 800 kg to the height position H of 200 mm to 400 mm and executing the substantially free falling is executed for 3 to 6 times, as the tapping process for the flex container bag 2. The conditions are however not limited to these and, for example, the height position H may be set in a range from 80 mm to 1,000 mm for the flex container bag 2 whose filling amount is in a range from 500 kg to 1,500 kg and the tapping process may be executed for 1 to 20 times. Especially, the height position H and the number of the tapping process sessions are desirably determined based on the property of the powder particle material to be filled with and the processing time periods at the process steps.

According to the filling method for a powder particle material of the filling apparatus 1 of this embodiment, the lifting operation is executed for the flex container bag 2 filled with the powder particle material and the dropping operation causing the flex container bag 2 to substantially freely fall to collide with the pallet 5 is thereafter executed.

The tension can be applied to mainly the side face of the flex container bag 2 and the force compressing the flex container bag 2 filled with the powder particle material in the width direction can be caused to act, by executing the lifting operation. The form of the flex container bag 2 filled with the powder particle material can thereby be arranged (shaped) to narrow the flex container bag 2 at least in the width direction. The inner pressure can also be applied to the powder particle material and the state can be established where the gaps among the powder particles are reduced and the powder particles become further dense with each other.

The air (the gaps) present among the filling powder particles is removed and the filling rate of the powder particle material in the flex container bag 2 can be increased by thereafter executing the dropping operation. Because the substantial free falling is executed in the state where the flex container bag 2 is filled with the powder particle material, the positional energy corresponding to the height position of the lifting and the self-weight can be applied to the powder particle material in the flex container bag 2 as the collisional energy and the filling rate can therefore be further increased. Because the tapping process is executed after the overall powder particle material is filled, the effect of the tapping process can be achieved for the overall filled powder particle material.

Because the dropping operation is executed in the state where the flex container bag 2 is shaped by the lifting operation to narrow the flex container bag 2 in the width direction, any expansion of the flex container bag 2 in the width direction even by the impact of the dropping can be suppressed. Because the impact by the dropping operation is applied to the powder particle material in the flex container bag 2 in the state where the inner pressure by the lifting is applied to the powder particle material, effective application of the collisional energy to the powder particle material is enabled. The filling rate of the powder particle material can thereby be further increased. Because a further strong impact is applied to the powder particle material by the dropping operation, the degree of dust generation (dusting) can be reduced in the flex container bag 2 after the tapping process.

The flex container bag 2 filled with the powder particle material as above is transported and stored in the state where the flex container bag 2 is placed on the pallet 5. The flex container bag 2 is handled together with the pallet 5 during the transportation and storage while avoidance of the fact that the flex container bag 2 becomes significantly larger than the width of the pallet 5 is desirable from the viewpoint of the handling property. According to the filling apparatus and the filling method of this embodiment, the tapping process is executed in the state where the flex container bag 2 is shaped to be narrowed in the width direction thereof. The flex container bag 2 can thereby be accommodated on the inner side of the pallet 5 without becoming larger than the inner side as far as possible, and the handling property for the transportation and the storage can further be improved.

For example, when transportation is executed using a container, the space in the width direction can further efficiently be used and the transportation efficiency can further be improved, by executing the shaping for the flex container bag 2 to be narrowed in the width direction by the tapping process as above.

The flex container bags 2 are often stored (stockpiled) in the state where the flex container bags 2 are stacked on each other in plural tiers such as, for example, the state where the flex container bags 2 are stacked on each other in two tiers (that is, a two-tier stacking state) to improve the storage efficiency.

Example of this disclosure will be described below while this disclosure is not limited at all by Example.

### Example

Filling of a water-absorbing resin, Aqua Keep SA60 (produced by Sumitomo Seika Chemicals Co., Ltd., having the bulk specific gravity of 0.7 mug, and having the median particle size of 350 μm) as the powder particle material was executed for a flex container bag (manufactured by Hagiwara Industries Inc., the material quality: polypropylene) in a filling amount of 800 kg using the filling apparatus of this disclosure. The filling of the powder particle material was executed at the frequency of about 20 bags/hour and the tapping process was executed by dropping the flex container bag for three times from the height of 300 mm. Work of moving the flex container bags each after the filling to a warehouse and stacking the flex container bags on each other in two tiers to be stored therein was conducted by six forklift operators for 30 days (the working hours per day: about 8 hours).

### Comparative Example

The 20 flex container bags were filled each in a filling amount of 800 kg in the same manner as that in Example except the fact that the elevating and lowering device 22 in its maintenance and inspection in the filling apparatus was not operated (that is, no dropping operation was executed), and the flex container bags were stored in a zone of a predetermined warehouse being stacked on each other in two tiers.

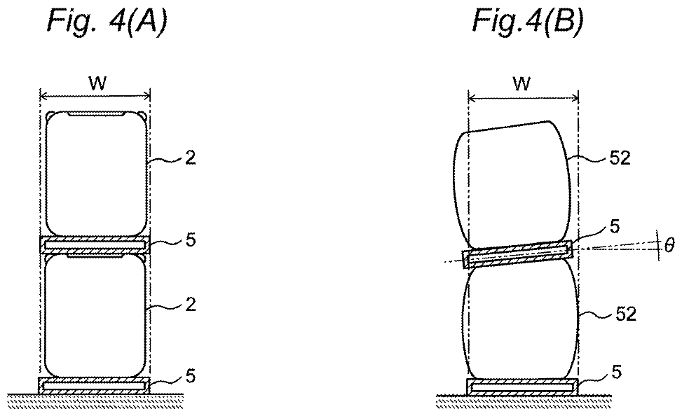

FIG. 4(A) depicts a schematic diagram of the case where the flex container bags 2 for which the filling of the powder particle material was executed using the filling method of this embodiment were stacked on each other in two tiers as Example. FIG. 4(B) depicts a schematic diagram of the case where the flex container bags 52 for which the filling of the powder particle material was executed using the traditional filling method were stacked on each other in two tiers as Comparative Example.

As to the flex container bags 52 according to Comparative Example of FIG. 4(B), the lifting operation was not executed for the flex container bags 52. The tension by the lifting operation was therefore not applied to especially the side face of each of the flex container bags 52 and the shaping process to narrow the flex container bag 52 in the width direction was not executed. When an impact was applied to the powder particle material by dropping the support bed having the flex container bag 52 placed thereon as in, for example, Patent Document 1 without executing the lifting operation, the side face of the flex container bag 52 expands to be inflated. The width of the flex container bag 52 may therefore become significantly larger than the width W of the pallet 5.

When a force is applied to the flex container bag 52 of Comparative Example from above, the flex container bag 52 tends to further be inflated in the width direction over time. Accordingly, as depicted in FIG. 4(B), when the flex container bags 52 are stacked on each other in two tiers, the flex container bags 52 in the lower tier may therefore be further inflated in the width direction and, associated with this, the pallet 5 between the upper tier and the lower tier may be inclined (for example, may be inclined at an inclination angle of θ against the horizontal direction). In this case, it is difficult to insert the arm part for receiving the luggage of a forklift into the pallet 5 and the handling property is degraded.

In contrast, for the flex container bag 2 of this embodiment, the dropping operation is executed in the tapping process in the state where the lifting operation is executed therefor and the flex container bag 2 is thereby shaped to be narrowed in the width direction. The flex container bag 2 can therefore be accommodated in the width W of the pallet 5 without becoming larger than the width W as far as possible. In addition, even when a force is applied from above to the flex container bag 2, the flex container bag 2 can be caused to tend to avoid inflating in the width direction over time, compared to the flex container bag 52 of Comparative Example. Even when the flex container bags 2 are stacked on each other in two tiers as depicted in FIG. 4(A), any inclination of the pallet 5 between the upper tier and the lower tier can be suppressed and the handling property for any forklift can be improved.

During the 30 days during which the work was continued, no complaint and no problem were reported from the operators and the workers on the site as to the flex container bags 2 of Example that were stacked on each other in the two tiers. In contrast, the forklift operators complained saying “the transportation and the two-tier stacking are difficult” despite the spot work as to the flex container bags 52 of Comparative Example that were stacked on each other in the two tiers. In Comparative Example, the flex container bags that were stacked on each other in the two tiers and that were left untouched for about two months included those that were generated even with inclination that was confirmed to the extent that the claws of a forklift cannot be inserted without lifting up each of those from above by a hoist to adjust the position thereof (those were again refilled using the method of Example).

Usually, even when improvement of the filling rate is aimed at by dropping an object having a mass of 500 kg or larger for plural times, collisions and frictions among the powder particles inside the flex container bag are worried about. Surprisingly, various properties of the water-absorbing resin before the Example and those after the Example were compared with each other and no substantial difference was confirmed. It can be considered that an unexpected effect of this disclosure is also achieved as to this point.

Properly combining any optional embodiments with each other, of the above various embodiments can cause each of the optional embodiments to achieve the effect to be achieved thereby.

This disclosure fully describes in relation to the preferred embodiment with reference to accompanying drawings while various deformations and various modifications are obvious for those skilled in the art. It should be understood that these deformations and modifications are encompassed in this disclosure without departing from the scope of this disclosure stipulated in the appended claims.

### EXPLANATIONS OF LETTERS OR NUMERALS

1 filling apparatus
2 flex container bag
3 opening
4 lifting belt (engaging part)
5 pallet
9 control device
10 powder particle material supplying device
11 hopper
12 shooter
13 cutting gate
14 blower
15 stretching and shortening part
16 supply entrance
17 load cell
20 lifting device
21 lifting chain
22 elevating and lowering device
30 pallet supplying device
40 carrying device

1. A filling apparatus for a powder particle material, comprising:
a powder particle material supplying device that supplies the powder particle material to a flexible container bag (hereinafter, referred to as “flex container bag”);
a lifting device that lifts up the flex container bag arranged on a floor surface or a base bed; and
a control device that is operable to control the lifting device to execute a tapping process including a lifting operation of lifting up the flex container bag filled with the powder particle material by the powder particle material supplying device by the lifting device to cause the flex container bag to be distant from the floor surface or the base bed thereabove and a dropping operation of dropping the flex container bag by releasing the lifting by the lifting device to cause the flex container bag to collide with the floor surface or the base bed.

2. The filling apparatus for a powder particle material according to claim 1, wherein
the lifting device comprises:
a lifting member that releasably engages with an upper portion of the flex container bag; and
an elevating and lowering device that elevates and lowers the lifting member, wherein
the elevating and lowering device comprises a lifting releasing function of causing the flex container bag lifted through the lifting member to substantially freely fall.

3. The filling apparatus for a powder particle material according to claim 1, wherein
the control device is operable to control the lifting device to execute the tapping process such that the flex container bag is lifted up to a height of at least 80 mm or higher from the floor surface or the base bed by the lifting operation and the dropping operation is thereafter executed.

4. A filling method for a powder particle material, comprising:
a powder particle material filling step of filling a flexible container bag (hereinafter, referred to as “flex container bag”) with the powder particle material by supplying the powder particle material to the flex container bag; and
a tapping step of executing a lifting operation of lifting up the flex container bag filled with the powder particle material to cause the flex container bag to be distant from a floor surface or a base bed thereabove and a dropping operation of dropping the flex container bag by releasing the lifting by the lifting operation to cause the flex container bag to collide with the floor surface or the base bed.

5. The filling method for a powder particle material according to claim 4, wherein
in the tapping step, the lifting operation is executed by elevating the lifting member that releasably engages with an upper portion of the flex container bag, and
the dropping operation is executed by releasing the lifting by the lifting member to cause the flex container bag to substantially freely fall.

6. The filling method for a powder particle material according to claim 4, wherein
in the tapping step, the flex container bag is lifted up to a height of at least 80 mm or higher from the floor surface or the base bed by the lifting operation and the dropping operation for the flex container bag is thereafter executed.

7. A storage method for flex container bags, comprising:
stacking on the flex container bags each other in a vertical direction in two or more tiers, each of the flex container bags being filled with a powder particle material in a filling amount of 500 kg to 1,500 kg using the filling method for a powder particle material according to claim 4.
